(19) United States
(12) Patent Application Publication
(10) Pub. No.: US 2004/0238730 A1
(43) Pub. Date: Dec. 2, 2004

(54) Fluorescence fluctuation microscope analytical module or scanning module, method for measurement of fluorescence fluctuation and method and device for adjustment of a fluorescence fluctuation microscope

(76) Inventors: Jorg Langowski, Heidelberg (DE); Malte Wachsmuth, Heidelberg (DE)

Correspondence Address: WILLIAM COLLARD, COLLARD & ROE, P.C., 1077 NORTHERN BOULEVARD, ROSLYN, NY, 11576, US

(21) Appl. No.: 10/477,153

(22) PCT Filed: May 7, 2002
(86) PCT No.: PCT/DE02/01649

(30) Foreign Application Priority Data
May 7, 2001 (DE) 101 22 046.4

(51) Int. Cl. H01J 3/14

(52) U.S. Cl. 250/234

(57) ABSTRACT

A fluorescence fluctuation microscope, in which excitation light and detection light are coupled into or out of a microscope by means of a common beam path, comprises a closed loop scanning unit (22, 23).

The invention relates to a fluorescence fluctuation microscope, a fluorescence fluctuation analytical module, or a fluorescence fluctuation scanning module, as well as to a method for measurement of fluorescence fluctuation. Furthermore, the invention relates to a method as well as a device for adjustment of a fluorescence fluctuation microscope.

A fluorescence fluctuation module is known from WO 98/23944, in which fluorescence fluctuation measurements, i.e. fluorescence correlation measurements and/or fluorescence cross-relation measurements can be performed even with commercially available microscopes, particularly with inverse microscopes. In the solution presented there, the corresponding measurement module is connected with an optical connection of a microscope, for example, whereby the paths of the excitation light and the measurement light are aligned confocally by the corresponding fluorescence fluctuation measurement module. This arrangement is particularly designed for the measurement of mobile particles or molecules, which pass through the focus because of their inherent movement, particularly because of Brownian molecular movement or molecular flow.

On the other hand, K. H. Berland et al., in “Scanning Two-Photon Fluctuation Correlation Spectroscopy: Particle Counting Measurements for Detection of Molecular Aggregation,” Biophysical Journal Volume 71, July 1996, pages 410 to 420, present a scanning fluorescence fluctuation measurement in which immobilized particles or molecules are periodically moved with reference to the excitation light, and a correlation function is determined from this. In this connection, the periodic movement can be achieved by periodic movement of the object carrier, on the one hand, or by a periodic movement of the excitation light, on the other hand. However, the scanning method presented there is not suitable for detecting mobile molecules or particles, since the necessary periodicity cannot be achieved with these, particularly if these molecules or particles leave the periodic path of the object carrier or the excitation light.

It has been shown that these known and very successful methods are not able to detect or follow non-immobilized molecules or particles to a sufficient degree. In this regard, the great advantages of fluorescence fluctuation spectroscopy, with its great sensitivity and selectivity with regard to fluorescence, which goes as far as the recognition of individual molecules, cannot be utilized for non-immobilized molecules.

It is the task of the present invention to make available a fluorescence fluctuation microscope and a method for fluorescence fluctuation measurement that eliminate the aforementioned disadvantages.

As a solution, the invention proposes a fluorescence fluctuation microscope in which the excitation light and the fluorescence light are coupled into a microscope by way of a common beam path, preferably confocally, or uncoupled from it, and which is characterized in that a closed-loop scanning unit is provided.

In contrast to the resonant scanning units used in the known scanning fluorescence fluctuation measurement, a closed-loop scanning unit makes it possible to move to a specific location and to hold the corresponding position over an extended period of time. This makes it possible to measure a sample at different positions, in targeted manner, whereby these measurements can be taken both according to WO 98/23944 A1 and according to the known scanning fluorescence fluctuation measurement, at a specific location, in each instance.

While a corresponding closed-loop scanning unit can be provided directly at the object carrier, it proves to be particularly advantageous if the corresponding closed-loop unit is provided in the common beam path of the detection light and the excitation light, so that the excitation light and the detection light are moved over the sample. In this manner, it is possible, for the first time, to record fluorescence fluctuation measurements also for moving molecules or particles, or for corresponding flows, whereby these flows can be followed in targeted manner. Furthermore, the invention makes it possible, for the first time, to measure a spatially extensive sample in its totality, with regard to fluorescence fluctuation, so that even complex relationships, such as those that occur in a biological cell, can be detected in their entirety.

It is true that laser scanning microscopes are known from DE 198 29 953 A1, from DE 197 33 195 A1, and from DE 43 23 129 A1, which can also be used for fluorescence measurements. Fluorescence fluctuation measurements are not mentioned in these documents. A glance at the embodiments presented in these references shows a person skilled in the art that these arrangements are not suitable for fluorescence fluctuation measurements, because of their complexity, the relatively long optical and therefore also mechanical paths between the beam splitter that separates the excitation light and the detection light, and the detectors, as well as on the basis of the pinhole arrangements provided per detector, the many other mechanical components, as well as the integrated lasers, since all of these components result in a significant background noise during fluorescence fluctuation measurements, on the one hand, as well as in correlated vibrations and therefore false measurement results. In this regard, while these arrangements are suitable for fluorescence measurements that are structured to be integrated over time, they are specifically not suitable for time-critical fluorescence fluctuation measurements.

Accordingly, the invention also proposes a method for fluorescence fluctuation measurement in which a closed-loop scanning unit focuses excitation light onto a specific location of a sample, and performs a fluorescence fluctuation measurement there, as well as in which the closed-loop scanning unit subsequently focuses the excitation light onto the sample at one location, and a fluorescence fluctuation measurement is also performed at this location. Independent of the other characteristics of the present invention, a fluorescence fluctuation microscope that comprises a microscope, a fluorescence fluctuation measurement module, for example according to WO 98/23944 A1, as well as a fluorescence fluctuation scanning module, is furthermore advantageous. In this manner, a device that functions according to the invention can be made available in relatively cost-effective manner, since only the corresponding scanning module has to be made available. In the case of such an arrangement, the fluorescence fluctuation measurement module can furthermore be easily utilized also for traditional fluorescence fluctuation measurements, particularly if the microscope-side connection of the fluorescence fluctuation scanning module is configured to be identical to the microscope-side connection of the fluorescence fluctuation measurement module. Accordingly, a fluorescence fluctuation scanning module having two connections, a first microscope-side connection and a second, measurement-module-side connection, is advantageous, in which the two connections are configured in complementary manner, even independent of the other characteristics of the present invention.

Preferably, a descanning lens is provided between the scanning unit and a beam splitter for the excitation light and the detection light, whereby in the present connection, the term “descanning lens” is understood to mean any optical arrangement by means of which focused beams can be split up into parallel beams. In particular, such a descanning lens can also be composed of several individual lenses. By means of such a descanning lens, an adjustment of the overall arrangement is facilitated, independent of the other characteristics of the present invention. This specifically makes it possible to adjust the excitation light and the detection light at first, particularly in confocal manner. This can be done, in particular, by way of the microscope, in known manner. Such an adjustment is particularly simplified significantly by means of the beam guidance, which would diverge without the descanning lens.

In connection with this, the descanning lens can easily be used and adjusted, whereby the only thing to which attention must be paid, in this connection, is that the beam path is sufficiently parallelized, because of the descanning lens. For this purpose, an adjustment holder having a marker that can be moved parallel to the optical axis, particularly one that can be connected with the descanning lens and removed, can be utilized.

It is understood that the descanning lens can be arranged on the microscope-side connection of the fluorescence fluctuation measurement module, on the one hand, or on the connection of the fluorescence fluctuation scanning module that faces away from the microscope. Preferably, the descanning lens can be adjusted relative to an optical arrangement of the fluorescence fluctuation measurement module, particularly relative to a pinhole.

Preferably, the scanning unit can be adjusted perpendicular to its optical axis, with reference to the optical axis of a detector arrangement and/or with reference to the optical axis of an excitation light source. This can be guaranteed, in particular, in that at least one of the corresponding connections is configured to be adjustable with reference to the remainder of the module, particularly adjustable perpendicular to the optical axis. In this manner, it can be assured, after a parallel beam of light has been produced by means of the descanning lens during the adjustment described above, that this beam passes through the scanning unit in optimal manner, i.e. that its optical axis agrees with the optical axis of the arrangement of the descanning lens and the excitation light or detection light path.

As already described above, the arrangement according to the invention makes it possible, for the first time, to use fluorescence fluctuation measurements in imaging manner. While the measurements in themselves can easily be performed in a reasonable time window, the related calculations that are necessary according to the state of the art proved to be so complex that it is hardly possible to speak of a “real time” record. In this regard, it is proposed, also independent of the other characteristics of the present invention, to evaluate the pure measurement results statistically, at first, and thereby to significantly reduce the number of data to be processed, before an actual correlation evaluation takes place. Such a method of procedure can particularly be implemented in the case of a fluorescence fluctuation microscope that has means for the location-resolved detection of the measured intensity and means for location-resolved detection of a correlation function that is integrated over time. These values can be determined in a manner that is relatively close to the actual time, and without significant effort, in a computer, on the one hand, and by means of devices provided locally, on the corresponding detectors, on the other hand. Subsequently, a correlation time can be determined directly, from the measured intensity and the integrated correlation function, and represented accordingly. In this manner, a location-resolved representation of a fluorescence fluctuation measurement can be offered to a user practically in “real time,” and this representation particularly includes the integrated correlation function, on the one hand, and the correlation time, on the other hand.

Further advantages, goals, and properties of the present invention will be explained using the drawing attached to the specification, in which a fluorescence fluctuation microscope according to the invention and an adjustment holder are shown schematically.

The drawing shows:

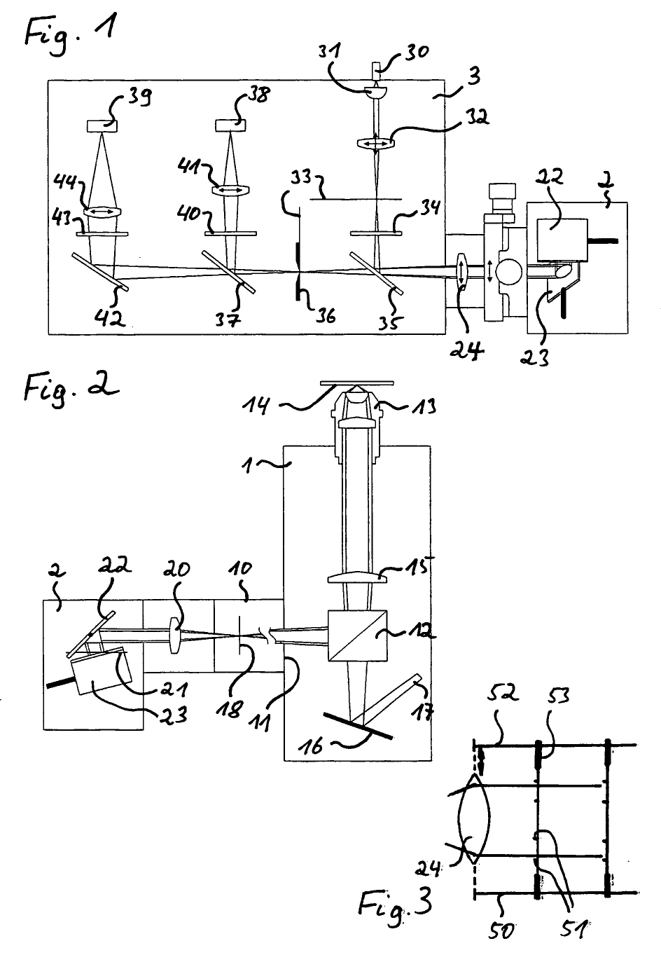

FIG. 1 one part of a fluorescence fluctuation scanning module, as well as a fluorescence fluctuation measurement module, in a schematic view,

FIG. 2 the other part of the fluorescence fluctuation scanning module, as well as a corresponding microscope, in a schematic view,

FIG. 3 a schematic representation of an adjustment holder according to the invention.

The fluorescence fluctuation microscope shown in FIGS. 1 and 2 comprises a commercially available microscope 1, in the tube 10 of which a scanning unit 2 is arranged, to which a fluorescence fluctuation measurement module 3 is attached, on the other hand. The fluorescence fluctuation measurement module 3 that is used in this exemplary embodiment, as an example, comprises a laser light input by way of a fiber 30, whereby the light that is emitted by the fiber is focused into a between-image plane 33 by means of a collimator 31 and a lens 32 having an adapted aperture. For this purpose, the lens 32 can be appropriately moved, in particular. The beam width of the excitation light beam serves as a light source for the arrangement described below, whereby the corresponding light is first passed onto a beam splitter 35 by means of an excitation filter 34. This beam splitter 35 reflects the excitation light and allows fluorescence light or detection light, which has a longer wavelength, to pass through, so that accordingly, two conjugated between-image planes 33 are produced. Proceeding from the beam splitter 35, the detection light is passed through a pinhole shutter, i.e. a pinhole 36 in the plane 33, which produced confocality, and divided up spectrally between two detectors 38 and 39, by means of a beam splitter 37. In this connection, the short-wave portion is reflected at the beam splitter 37, and imaged onto the detector 38 by means of an emission filter 40 as well as a detection lens 41. Analogously, the long-wave portion that passes through the beam splitter 37 is imaged onto the second detector 39 by a lens 44, by way of a mirror 42 and a filter 43.

In this exemplary embodiment, the pinhole 36 functions as a reference point for the adjustment. In this connection, the lenses 41 and 44 are moved until the pinhole 36 is imaged on the detectors 38 and 39. Furthermore, the lens 32, as well as the collimator 31, if necessary, are also adjusted in such a manner that the laser beam width and the pinhole 36 are arranged in conjugated confocal manner.

In the exemplary embodiment shown in FIGS. 1 and 2, an inverse microscope 1 having a lateral optical output 11 is used, which output can also be used for connecting CCD cameras or discussion devices. In case of the microscope 1 being used here, a beam splitter cube 12 passes approximately 80% of the light that comes from a sample arranged on a sample carrier 14, from a lens 13 by way of a tube lens 15, to the lateral output 11, and 20% to an eyepiece 17, by way of a mirror 16. It is understood that other microscopes as well as other microscope outputs can also be used for an implementation according to the invention.

An intermediate plane 18 is provided in the tube 10 of the microscope 1, which is utilized as a focal plane for the fluorescence fluctuation measurement module 3 and for the fluorescence fluctuation scanning module 2, respectively. It is understood that for this purpose, an intermediate plane of the microscope 1 that is present at a different location and can be used in suitable manner can be utilized. Furthermore, the arrangement according to the invention can also be implemented without utilizing such a between-image plane, whereby the use of a between-image plane, in comparison, allows relatively simple implementation of the invention, particularly also with other microscopes, since it only has to be assured by means of suitable connections that a between-image plane made available in appropriate manner can be utilized as a focal plane.

The fluorescence fluctuation scanning module 2 comprises a scanning lens 20 at its microscope-side connection, the focal plane of which lens coincides with the between-image plane 18 when the scanning module 2 is connected with the microscope 1. On the image side, a telecentric plane 21 of the scanning lens 20 lies between two mirrors 22, 23 of a galvanometer scanner. In the present exemplary embodiment, rotating magnet galvanometer scanners, in particular, have proven themselves to be particularly advantageous. In this connection, the axis of rotation of the mirror 23 is tipped from the horizontal by 15°, in order to achieve the smallest possible distance between the mirrors, which is approximately 23.5 mm on the optical axis. These galvanometer scanners are configured as closed-loop scanners, so that they can maintain a deflection once it has been reached. In this way, a position can be approached in targeted manner, and the fluorescence fluctuation can be measured. It is understood that such closed-loop scanners can also be utilized for moving the sample holder 14. The use of a scanning unit in the light path has the advantage, however, that significantly smaller masses have to be moved. By means of a suitable selection of the masses of the mirrors, influences of the scanning unit that would falsify the measurement can be prevented or minimized. Likewise, the control circuits that are present in the case of closed-loop scanning units can be optimally designed to this end.

When the scanner mirrors are rotated, the focus migrates in the between-image plane 18 as well as in the lens plane of the microscope. A collimation lens or descanning lens 24 accordingly focuses the light onto the between-image plane 33, whereby the aperture angle in this case is selected to be identical to the aperture angle of the light that exits from the microscope 1 at the output 11. This aperture adjustment makes it possible to remove the fluorescence fluctuation scanning module 2, consisting of the tube 10, the scanning lens 20, the scanners 22, 23, and the descanning lens 24, from the beam path between the output 11 and the fluorescence fluctuation measurement module 3, and to connect the fluorescence fluctuation module 3 directly to the output 11, or to install a different confocal lens system on the scanning module 2, instead of the fluorescence fluctuation measurement module 3.

For adjustments, the descanning lens 24 can be particularly moved laterally, i.e. perpendicular to the optical axis. Preferably, an auxiliary frame 50 is provided for adjustment of the descanning lens 24, which can be attached to the descanning lens 24, in order to suitably align the latter. This auxiliary frame is configured in such a way that it can be used to check the parallelity of the beam of light that leaves the descanning lens 24, using suitable markers 51 (numbered as examples in FIG. 3), and that the descanning lens 24 can be appropriately readjusted. For this purpose, in the present exemplary embodiment the adjustment holder has two guides 52, on which a screen 53 is arranged so that it can be moved in parallel manner, which screen bears the corresponding markers 51. The parallelity of the beam of light can easily be checked by means of a parallel displacement of the screen 53.

Furthermore, a mechanical stage 25 is also arranged on the fluorescence fluctuation scanning module 2, by means of which the optical axes of the fluorescence fluctuation measurement module 3 and of the fluorescence fluctuation scanning module 2 can be brought into alignment.

The outputs of the detectors 38 and 39 are connected with an appropriate evaluation device, particularly with an appropriate computer. The latter can, in particular, have separate inputs or cards, with which individual functions can be easily controlled. This can be, for example, a correlator card for recording the correlation function, as well as a counter card, whereby in this connection, the counter card makes the sampling rates, which are unusually high for usual correlator cards, available for the scanning microscopy. The necessary calculations can also be performed in these cards, to a sufficient degree, so that the computer does not have to intervene directly. It is understood, however, that the computer can also be utilized for these calculations, particularly in supporting manner.

During measurement operation, the detector signal of the detectors 38, 39 is then first recorded in photon counting operation, as is usual also for known fluorescence fluctuation spectroscopy, integrated over time intervals Δτ of 10 μs, for example, for a defined time of 50 ms, for example (in other words 5000 intervals). Subsequently, the autocorrelation or cross-correlation function is calculated from these data, depending on whether single-channel operation or two-channel operation is involved, G(τ) for τ>0. The calculation of the correlation function from the measured photon pulses kᵢ, i=1 . . . N, totaled over a time interval Δτ, in each instance, in N consecutive intervals, can be performed rapidly, in the present example, as follows:

$$\begin{matrix}G ( n \cdot Δ τ ) = \frac{\frac{1}{N - n} {\sum }_{i = 1}^{N - n} {k}_{i} {k}_{i + n}}{{( \frac{1}{N} {\sum }_{i = 1}^{N} {k}_{i} )}^{2}} - 1 f \dot{u} r & n \geq \end{matrix} 1$$

Furthermore, a calculation of the amplitude G(0) takes place from these data, which, in the case of diffusion, is inversely proportional to the particle count in the focus, and thereby inversely proportional to the concentration. The calculation of the amplitude G(0) from the counted photon pulses can take place as follows, in the present example:

$$G ( 0 ) = N \frac{{\sum }_{i = 1}^{N} {k}_{i}^{2} - {\sum }_{i = 1}^{N} {k}_{i}}{{( {\sum }_{i = 1}^{N} {k}_{i} )}^{2}} - 1$$

For diffusion-induced signal fluctuations, integration by way of the correlation function ζdτ G(τ)=c·τ_{d}·G(0), where τ_{d} is the correlation time or decay time of the signal correlations (in the case of diffusion, the average dwell time of the molecules in the focus and inversely proportional to the diffusion coefficient), and the constant c can be determined numerically or analytically. However, the constant c can also be determined using a single conventional FCS measurement in the same sample.

By means of the numerical integration of G(τ), τ_{d} is therefore also known. It can take place as follows, for example:

$$Δ τ \cdot {\sum }_{n = 1}^{N / 2} G ( n \cdot Δ τ )$$

In this regard, τ_{d} can be represented on the basis of the values totaled or integrated over time, as above, as a correlation time, using suitable means, for example by means of visualization on a monitor, particularly also practically in “real time.” The calculations are very fast on today's computers, and can take place in parallel to the point-by-point recording of data. Using the existing configuration, it is therefore possible to move to points or locations for short periods of time (e.g. 50 ms) , one after the other, in a raster, so that data recording can then take place point by point.

Therefore, in this manner, images with the intensity distribution, with the concentration, as a correlation function integrated over time, and with the correlation time as the contrast-giving signal, can be produced very rapidly, without any further effort with regard to data analysis or the like being necessary.

1. Fluorescence fluctuation microscope, in which the excitation light and the detection light are coupled into a microscope (1) by way of a common beam path, preferably confocally, or uncoupled from it, characterized in that a closed-loop scanning unit (22, 23) is provided in the common beam path.

2. Fluorescence fluctuation microscope according to claim 1, characterized in that the scanning unit (22, 23) comprises at least two mirrors (22, 23).

3. Fluorescence fluctuation microscope according to claim 1, comprising a microscope (1), a fluorescence fluctuation measurement module (3), as well as a fluorescence fluctuation scanning module (2).

4. Fluorescence fluctuation microscope according to claim 1, characterized by a descanning lens (24) between the scanning unit (22, 23) and a beam splitter (35) for the excitation light and the detection light.

5. Fluorescence fluctuation microscope according to claim 1, characterized in that the scanning unit (22, 23) can be adjusted perpendicular to its optical axis, with reference to the optical axis of a detector arrangement (38, 41, 36; 39, 44, 36) and/or with reference to the optical axis of an excitation light source (31, 32).

6. Fluorescence fluctuation microscope according to claim 1, characterized by means for location-resolved detection of the measured fluorescence intensity, having means for location-resolved detection of a correlation function integrated over time, and having means for displaying a correlation time.

7. Fluorescence fluctuation microscope according to claim 6, characterized in that the means for location-resolved detection of the measured fluorescence intensity and/or the means for location-resolved detection of the correlation function integrated over the time axis are provided in a unit that is separate from an evaluation computer.

8. Fluorescence fluctuation measurement module (3) having a microscope-side connection, characterized by a descanning lens (24) at the connection.

9. Fluorescence fluctuation scanning module (2) having a connection facing away from a microscope, characterized by a descanning lens (24) at the connection.

10. Fluorescence fluctuation scanning module according to claim 9, characterized by two connections, a first one for a microscope (1) and a second one for a measurement module (3), whereby the two connections are configured to be complementary to one another.

11. Fluorescence fluctuation measurement module according to claim 8 or fluorescence fluctuation scanning module, characterized in that the descanning lens is adjustable with reference to an optical arrangement, particularly with reference to a pinhole (36).

12. Fluorescence fluctuation measurement module or fluorescence fluctuation scanning module according to claim 8, characterized in that the connection is adjustable with reference to the remainder of the module, particularly adjustable perpendicular to the optical axis.

13. Method for fluorescence fluctuation measurement of a sample by means of a beam path directed to the sample, in which a closed-loop scanning unit (22, 23) provided in the beam path focuses excitation light onto a sample, at a certain location, and a fluorescence fluctuation measurement is performed at this location, as well as that subsequently, the closed-loop scanning unit (22, 23) focuses the excitation light on the sample at another location, and a fluorescence fluctuation measurement is also performed at this location.

14. Method for adjusting a fluorescence fluctuation microscope according to claim 1, characterized in that first, an excitation light path as well as a detection light path, and subsequently a descanning lens (24) are adjusted.

15. Method according to claim 14, characterized in that after the adjustment of the scanning lens (24), the scanning unit (22, 23) is adjusted.

16. Device for adjusting a fluorescence fluctuation microscope (24), characterized by an adjustment holder (50) that can be connected with the descanning lens (24), and removed, having a marker (51) that can be moved parallel to the optical axis.
